(19) United States
(12) Patent Application Publication
(10) Pub. No.: US 2008/0014452 A1
(43) Pub. Date: Jan. 17, 2008

(54) Transparent Conductive Material, Transparent Conductive Paste, Transparent Conductive Film and Transparent Electrode

(75) Inventor: Noriyuki Yasuda, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 11/597,133

(22) PCT Filed: May 20, 2005
(86) PCT No.: PCT/JP05/09260

§ 371 Date: Apr. 17, 2007

(30) Foreign Application Priority Data
May 21, 2004 (JP) 2004-152444
Apr. 28, 2005 (JP) 2005-133156

(51) Int. Cl. H01B 1/08; B32B 9/00

(52) U.S. Cl. 428/469; 252/512; 252/514; 252/518.1; 252/519.5; 252/520.1; 428/702

(57) ABSTRACT

The present invention is a transparent conductive material containing indium oxide, and makes a mixed liquid containing 1 wt % of the transparent conductive material attain a pH of at least 3. The present invention can provide a transparent conductive material, a transparent conductive paste, a transparent conductive film, and a transparent electrode which can fully prevent the resistance value from changing with time even in a high-humidity environment.

### TECHNICAL FIELD

The present invention relates to a transparent conductive material, a transparent conductive paste, a transparent conductive film, and a transparent electrode.

### BACKGROUND ART

LCD, PDP, organic EL, touch panels, and the like use transparent electrodes, which are constructed by transparent conductive materials. Conventionally known as such transparent conductive materials are metal oxides such as tin oxide, indium-tin mixed oxides, indium oxide, zinc oxide, and zinc-antimony mixed oxides. These transparent conductive materials are formed as films on substrates by many methods such as sputtering, vapor deposition, ion plating and CVD, and are utilized as transparent conductive films.

These transparent conductive materials can be manufactured inexpensively and thus have recently been formed as transparent conductive layers and the like by using liquid-phase syntheses.

The transparent conductive materials obtained by the liquid-phase syntheses have a merit in that they can be manufactured inexpensively, but tend to contain a large amount of halogen elements as impurities since chlorides containing halogens in molecules such as indium chloride tetrahydrate are used in general. Consequently, the transparent electrodes using the transparent conductive materials obtained by the liquid-phase syntheses are problematic in that their resistance value becomes unstable or greater under the influence of impurities.

Therefore, ITO conductive powders with reduced concentrations of chlorine and the like acting as impurities have been proposed in order to stabilize or lower the resistance value (see, for example, the following Patent Document 1).

Patent Document 1: Japanese Patent Application Laid-Open No. HEI 05-201731

### DISCLOSURE OF THE INVENTION

### Problem to be Solved by the Invention

However, the inventors found that there was a case where the resistance value rose when the ITO conductive powder disclosed in the above-mentioned Patent Document 1 was used for a long period in a high-humidity environment in particular.

In view of the circumstances mentioned above, it is an object of the present invention to provide a transparent conductive material, a transparent conductive paste, a transparent conductive film, and a transparent electrode which can fully prevent the resistance value from changing with time even in the high-humidity environment.

### Means for Solving Problem

The inventors conducted diligent studies in order to solve the problem mentioned above. For example, the inventors performed x-ray diffraction for tin-doped indium oxide (ITO) in a high-temperature high-humidity environment, and found a peak corresponding to In(OH)₃ in the x-ray diffraction spectrum. The inventors took notice of this peak, and wondered if In(OH)₃ corresponding to this peak blocked conductive paths between ITO particles and thereby caused the resistance value to change with time. Then, the inventors presumed that In(OH)₃ was generated in the high-humidity environment because the ITO particles absorbed moisture, so that dissociable hydrogen atoms present in the ITO particles and halogen elements contained as impurities in the ITO particles combined together to generate halogenated hydrogen, which etched the ITO particles, thereby ionizing indium, and the resulting indium ions combined with moisture. Based on such a presumption, the inventors further conducted diligent studies and have found that the above-mentioned problem can be solved by the following invention, thereby completing the present invention.

Namely, the present invention is a transparent conductive material containing indium oxide or an indium mixed oxide made by doping indium oxide with at least one species of element selected from the group consisting of tin, zinc, tellurium, silver, gallium, zirconium, hafnium, and magnesium; wherein the transparent conductive material makes a mixed liquid containing 1 wt % of the transparent conductive material attain a pH of at least 3, preferably 4 to 9.

In another aspect, the present invention is a transparent conductive material containing indium oxide or an indium mixed oxide made by doping indium oxide with at least one species of element selected from the group consisting of tin, zinc, tellurium, silver, gallium, zirconium, hafnium, and magnesium; wherein the transparent conductive material makes a mixed liquid containing 1 wt % of the transparent conductive material attain a pH of less than 3 and has a halogen element concentration of 0.2 mass % or less.

In still another aspect, the present invention is a transparent conductive material containing tin oxide or a tin mixed oxide made by doping tin oxide with at least one species of element selected from the group consisting of antimony, zinc, and fluorine; wherein the transparent conductive material makes a mixed liquid containing 1 wt % of the transparent conductive material attain a pH of at least 1 and has a halogen element concentration of 1.5 mass % or less.

In still another aspect, the present invention is a transparent conductive material containing zinc oxide or a zinc mixed oxide made by doping zinc oxide with at least one species of element selected from the group consisting of aluminum, gallium, indium, boron, fluorine, and manganese; wherein the transparent conductive material makes a mixed liquid containing 1 wt % of the transparent conductive material attain a pH of 4 to 9.

These transparent conductive materials can fully prevent the resistance value from changing with time even in the high-humidity environment.

Still another aspect of the present invention is a transparent conductive paste containing the above-mentioned transparent conductive material. Still another aspect of the present invention is a transparent conductive film containing the above-mentioned transparent conductive material. Still another aspect of the present invention is a transparent electrode comprising a substrate and a transparent conductive layer provided on one side of the substrate, the transparent conductive layer containing the above-mentioned transparent conductive material.

These aspects of the present invention contain the above-mentioned transparent conductive material, and thus can fully prevent the resistance value from changing with time even in the high-humidity environment.

### Effect of the Invention

The present invention can provide a transparent conductive material, a transparent conductive paste, a transparent conductive film, and a transparent electrode which can fully prevent the resistance value from changing with time even in the high-humidity environment.

### BRIEF DESCRIPTION OF THE DRAWINGS

FIG. 1 is a schematic sectional view showing one embodiment of the transparent electrode in accordance with the present invention.

FIG. 2 is a sectional view showing an apparatus for measuring compressed powder resistance in Examples.

### EXPLANATIONS OF NUMERALS

1 . . . transparent electrode; 10 . . . substrate; 20 . . . transparent conductive layer; 30 . . . compressed powder resistance measuring apparatus; 31 . . . stainless jig; 31a . . . projection; 32 . . . drum; 33 . . . inner; 35 . . . sample; 36 . . . cylinder.

### BEST MODES FOR CARRYING OUT THE INVENTION

In the following, preferred embodiments of the present invention will be explained with reference to the accompanying drawings when necessary.

### First Embodiment

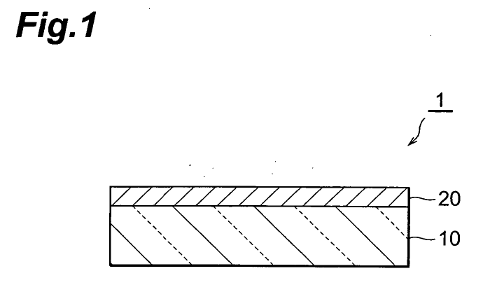

To begin with, a first embodiment of the transparent electrode in accordance with the present invention will be explained. FIG. 1 is a schematic sectional view showing one embodiment of the transparent electrode in accordance with the present invention. The transparent electrode 1 in accordance with this embodiment comprises a substrate 10 and a transparent conductive layer 20, formed on one side of the substrate 10, containing a transparent conductive material. Here, the transparent conductive material included in the transparent conductive layer 20 contains indium oxide.

The transparent conductive material makes a mixed liquid containing 1 wt % of the transparent conductive material attain a pH of at least 3. This transparent conductive material can fully prevent the resistance value from changing with time even in the high-humidity environment regardless of the halogen element concentration in indium oxide. Though the reason therefor is unclear, it seems to be because the transparent conductive material making the mixed liquid containing 1 wt % of the transparent conductive material attain a pH of at least 3 can fully decrease dissociable hydrogen atoms, so that halogenated hydrogen generated, if any, fails to dissolve the transparent conductive material, and In(OH)₃, which is an insulator, is fully restrained from being generated, whereby the resistance value of the transparent conductive material is fully kept from rising.

Using this transparent conductive material can fully raise the transmittance of the transparent electrode 1 as compared with using a transparent conductive material making a mixed liquid containing 1 wt % of the transparent conductive material attain a pH of less than 3 and having a halogen element concentration exceeding 0.2 mass %. Though the reason therefor is also unclear, it seems to be because the use of the above-mentioned transparent conductive material fully restrains indium hydroxide from being generated, thereby sufficiently suppressing the consequent scattering of light.

Here, the transparent conductive material is preferably one making the mixed liquid containing 1 wt % of the transparent conductive material attain a pH of at least 4. One making the mixed liquid containing 1 wt % of the transparent conductive material attain a pH of less than 4 tends to have a higher possibility of the transparent conductive material generating eluates such as indium ions and tin ions as compared with the one yielding a pH of at least 4. Preferably, the transparent conductive material is one making the mixed liquid containing 1 wt % of the transparent conductive material attain a pH of 9 or less. One yielding a pH exceeding 9 has a higher possibility of byproducts such as sodium ions and ammonium ions generated when manufacturing the transparent conductive material by using indium being absorbed to the surface of the transparent conductive material and lowering properties.

More preferably, the transparent conductive material is one making the mixed liquid containing 1 wt % of the transparent conductive material attain a pH of at least 3 and having a halogen element concentration of 0.2 mass % or less. This can more fully prevent the resistance value from rising as compared with the case where the halogen element concentration exceeds 0.2 mass %.

Alternatively, the transparent conductive material may be one making the mixed liquid containing 1 wt % of the transparent conductive material attain a pH of less than 3 and having a halogen element concentration of 0.2 mass % or less. This can also prevent the resistance value from changing with time even in the high-humidity environment. This seems to be because one making the mixed liquid containing 1 wt % of the transparent conductive material attain a pH of less than 3 may fully generate halogenated hydrogen, but sufficiently suppresses the generation of halogenated hydrogen when the halogen element concentration in the transparent conductive material is 0.2 mass % or less.

The above-mentioned transparent conductive material is usually in the form of powder. In this case, it will be preferred if the powder made of the transparent conductive material has an average particle size of 10 to 80 nm. When the average particle size is less than 10 nm, the conductivity of the transparent conductive material tends to be unstable. Namely, though conductivity occurs because of oxygen defects in the transparent conductive material in accordance with the present invention, the transparent conductive material having such a small particle size may decrease the oxygen defects when the external oxygen concentration is high, for example, whereby the conductivity may fluctuate. When the average particle size exceeds 80 nm, on the other hand, the scattering of light becomes greater in the wavelength region of visible light, for example, whereby the transmittance of the transparent electrode 1 tends to decrease in the wavelength region of visible light, thus increasing the haze value.

Preferably, the powder made of the above-mentioned transparent conductive material has a specific surface area of 10 to 50 m²/g. The scattering of light tends to become greater when the specific surface area is less than 10 m²/g, whereas the transparent conductive material tends to be less stable when the specific surface area exceeds 50 m²/g. The specific surface area herein refers to the value measured by using a specific surface area measuring apparatus (type: NOVA2000 manufactured by Quantachrome Instruments) after vacuum-drying a sample at 300° C. for 30 minutes.

The above-mentioned substrate 10 is not limited in particular as long as it has transparency, whereas it will be preferred if the material constituting the above-mentioned substrate 10 is excellent in transparency. Specific examples of such a material include not only glass but also films of polyester, polyethylene, polypropylene, and the like.

The above-mentioned indium oxide may be doped with at least one species of element selected from the group consisting of tin, zinc, tellurium, silver, gallium, zirconium, hafnium, and magnesium. In other words, the above-mentioned transparent conductive material may contain an indium mixed oxide. This can also fully prevent the resistance value from changing with time even in the high-humidity environment. From the point of fully restraining the resistance value from changing with time, tin is preferred among the elements mentioned above.

The above-mentioned transparent electrode 1 can be manufactured in the following manner.

Namely, a metal chloride and chlorides of elements if any with which indium oxide is to be doped are neutralized with an alkali, so as to coprecipitate (precipitating step). Indium is used as the above-mentioned metal in this embodiment. Salts yielded as byproducts here are eliminated by decantation or centrifugation. Since thus obtained coprecipitate is included in a medium, the medium is dried, and the resulting coprecipitate is subjected to firing and pulverizing processes. Thus, a powdery transparent conductive material is manufactured. From the viewpoint of fully restraining impurities from being generated, it will be preferred if the above-mentioned firing process is performed in a nitrogen atmosphere or a noble gas atmosphere of helium, argon, xenon, or the like.

Next, the powder made of the transparent conductive material is dispersed in a liquid, and the resulting dispersion liquid is applied onto one surface of the substrate 10. Examples of the liquid for dispersing the transparent conductive material include water; saturated hydrocarbons such as hexane; aromatic hydrocarbons such as toluene and xylene; alcohols such as methanol, ethanol, propanol, and butanol; ketones such as acetone, methylethylketone, isobutylmethylketone, and diisobutylketone; esters such as ethyl acetate and butyl acetate; ethers such as tetrahydrofuran, dioxane, and diethyl ether; and amides such as N,N-dimethylacetamide, N,N-dimethylformamide, and N-methylpyrrolidone.

Preferably, a binder is added into the above-mentioned liquid in order to bond transparent conductive materials to each other and attain a uniform thickness in the transparent conductive layer 20. For example, methyl polymethacrylate can be used as the binder.

The method of applying the dispersion liquid onto the substrate 10 is not limited in particular, whereby known methods can be used. Examples include reverse rolling, direct rolling, blading, knifing, extrusion, nozzle method, curtaining, gravure rolling, bar coating, dipping, kiss coating, spin coating, squeezing, and spraying.

Next, the above-mentioned dispersion liquid is dried. Thus, the transparent conductive layer 20 is formed on one side of the substrate 10, whereby the transparent electrode 1 is obtained.

For adjusting the pH of the mixed liquid containing 1 wt % of the transparent conductive material obtained as mentioned above (the concentration of dissociable hydrogen atoms present in the transparent conductive material), it will be sufficient if the pH of the solution at the time of the above-mentioned neutralizing process is regulated. For example, making the above-mentioned solution alkaline allows the resulting powdery transparent conductive material to become alkaline, whereby the above-mentioned mixed liquid can attain a higher pH. When the amount of alkali used for yielding the coprecipitate is made smaller, so as to lower the pH, by contrast, the resulting powdery transparent conductive material can be made acidic, whereby the pH of the above-mentioned mixed liquid can be lowered. Fully washing the transparent conductive material after manufacturing it can adjust the pH of the mixed liquid from the acidic region to the neutral region.

The halogen element concentration (e.g., chlorine concentration) in the transparent conductive material can be regulated by the neutralizing method in the above-mentioned precipitating step. Namely, when a sufficient neutralizing process is not performed in the above-mentioned precipitating step, the resulting powdery material includes an unreacted chloride (e.g., indium chloride), whereby the halogen element concentration in the transparent conductive material can be made higher. When a sufficient neutralizing process is performed in the above-mentioned precipitating step, so as to place the solution into the neutral or alkaline region, the amount of chlorine in the resulting powdery transparent conductive material can be decreased, whereby the halogen element concentration in the transparent conductive material can be lowered.

The transparent conductive material having a higher halogen element concentration (e.g., about 0.5 wt %) and making the mixed liquid containing 1 wt % of the transparent conductive material attain a lower pH (e.g., pH of 3.1) can be obtained by decreasing the amount of alkali used in the neutralizing process and shortening the neutralizing time without fully stirring the solution in the above-mentioned precipitating step.

Further, the transparent conductive material having an undetectably low halogen element concentration and lowering the pH of the above-mentioned mixed liquid can be obtained by employing indium nitrate or the like as an indium source used in the above-mentioned precipitating step and performing the above-mentioned precipitating step in the acidic region.

The method of adjusting the halogen element concentration is not limited to the above, whereby methods of vaporizing halogens by raising the heating temperature at the time of generating oxides, methods of exchanging ions by using ion-exchange membranes, methods of removing halogen elements from within the impurities by sufficient washing, and the like can be used.

The halogen element concentration in the transparent conductive material can also be lowered by subjecting the transparent conductive material to a water-washing step. In this case, however, the efficiency in removing halogen elements decreases as the halogen element concentration is lower, whereby the halogen element concentration cannot be lowered sufficiently. Therefore, for further lowering the halogen element concentration, an alkali-washing step of washing with an alkali solution is added to the above-mentioned water-washing step. This can raise the efficiency of removing halogen elements from within the transparent conductive material, and thus can sufficiently lower the halogen element concentration to an undetectable level.

When employing a dispersion liquid using no binder, it will be sufficient if the dispersion liquid is applied onto one side of the substrate 10 and dried, so as to form a transparent conductive layer 20 containing the transparent conductive material, and then the transparent conductive layer 20 is compressed, so as to form a compressed layer of the transparent conductive material. This is useful in that the transparent conductive layer 20 can be attached to the substrate 10 without using a binder. The compression can be effected by sheet press, roll press, and the like. Further, binders can be infiltrated into the compressed layer, so as to fix the transparent conductive material.

### Second Embodiment

A second embodiment of the transparent electrode in accordance with the present invention will now be explained.

The transparent electrode of this embodiment differs from the transparent electrode of the first embodiment in that it uses a transparent conductive material containing tin oxide instead of indium oxide, making the mixed liquid containing 1 wt % of the transparent conductive material attain a pH of at least 1, and having a halogen element concentration of 1.5 mass % or less.

This transparent electrode contains the above-mentioned transparent conductive material, and thus can fully prevent the resistance value from changing with time even in the high-humidity environment. Using this transparent conductive material can more fully raise the transmittance of the transparent electrode as compared with the case using a transparent conductive material making the mixed liquid containing 1 wt % of the transparent conductive material attain a pH of less than 1 and having a halogen element concentration exceeding 1.5 mass %.

More preferably, the halogen element concentration in the above-mentioned transparent conductive material is 1.0 mass % or less. This is advantageous in that the moisture resistance characteristic improves as compared with the case where the halogen element concentration exceeds 1.0 mass %.

The above-mentioned tin oxide may be doped with at least one species of element selected from the group consisting of antimony, zinc, and fluorine. In other words, the above-mentioned transparent conductive material may contain a tin mixed oxide. This can also fully prevent the resistance value from changing with time even in the high-humidity environment. From the point of fully restraining the resistance value from changing with time, antimony is preferred among the elements mentioned above.

### Third Embodiment

A third embodiment of the transparent electrode in accordance with the present invention will now be explained.

The transparent electrode of this embodiment differs from the transparent electrode of the first embodiment in that it uses a transparent conductive material containing zinc oxide instead of indium oxide and making the mixed liquid containing 1 wt % of the transparent conductive material attain a pH of 4 to 9.

This transparent electrode contains the above-mentioned transparent conductive material, and thus can fully prevent the resistance value from changing with time even in the high-humidity environment. Using this transparent conductive material can more fully raise the transmittance of the transparent electrode as compared with the case using a transparent conductive material making the mixed liquid containing 1 wt % of the transparent conductive material attain a pH of less than 4 or greater than 9. Making the mixed liquid containing 1 wt % of the transparent conductive material attain a pH exceeding 9 tends to promote deterioration at a high temperature and high humidity.

Preferably, the above-mentioned transparent conductive material makes the mixed liquid containing 1 wt % of the transparent conductive material attain a pH of at least 5. This is advantageous in that it can decrease impurities as compared with a transparent conductive material making the mixed liquid containing 1 wt % of the transparent conductive material attain a pH of less than 5. Preferably, the halogen element concentration in the transparent conductive material is 0.05 mass % or less. This can more fully prevent the resistance value from rising even in the high-humidity environment.

The above-mentioned zinc oxide may be doped with at least one species of element selected from the group consisting of aluminum, gallium, indium, boron, fluorine, and manganese. In other words, the above-mentioned transparent conductive material may contain a zinc mixed oxide. This can also fully prevent the resistance value from changing with time even in the high-humidity environment. From the point of fully restraining the resistance value from changing with time, Al and Ga are preferred among the elements mentioned above.

The present invention is not limited to the above-mentioned embodiments. For example, though the above-mentioned embodiments relate to transparent electrodes, the present invention may be a transparent conductive paste containing the above-mentioned transparent conductive material. This transparent conductive paste includes the above-mentioned transparent conductive material. Consequently, this transparent conductive paste can fully prevent the resistance value from changing with time even in the high-humidity environment. The transparent conductive paste has a constant viscosity and thus can be applied uniformly to the substrate 10 and easily to narrow and depressed/protruded parts.

This transparent conductive paste can be obtained by adding a viscosity-increasing agent such as acrylic resin to the above-mentioned dispersion liquid and drying the resulting mixture.

The present invention may also be a transparent conductive film containing the above-mentioned transparent conductive material. For yielding this transparent conductive film, it will be sufficient if the above-mentioned dispersion liquid is doped with acrylic monomers, epoxy monomers, and the like and is cured by UV irradiation, EB irradiation, or heating.

Though the transparent conductive layer 20 and the substrate 10 are directly in contact with each other in the above-mentioned embodiments, it will be preferred if the transparent electrode of the present invention comprises an anchor coat layer, provided between the transparent conductive layer 20 and the substrate 10, for enhancing the bonding strength of the transparent conductive layer to the substrate 10. Resins of urethane and the like, for example, are used as the anchor coat layer.

### EXAMPLES

In the following, the present invention will be explained more specifically with reference to examples, which do not limit the present invention.

### Examples 1 to 6 and 8 to 10

An aqueous solution dissolving 19.9 g of indium chloride tetrahydrate (manufactured by Kanto Chemical Co., Inc.) and 2.6 g of stannic chloride (manufactured by Kanto Chemical Co., Inc.) into 980 g of water and a 10-fold water dilution of aqueous ammonia (manufactured by Kanto Chemical Co., Inc.) were mixed while being compounded so as to yield a pH of about 5 to 7 in Examples 1 to 6, a pH of about 7 in Example 8, and a pH of about 9 in Examples 9 and 10, thereby generating a white precipitate (coprecipitate).

The liquid containing thus produced precipitate was subjected to solid-liquid separation by a centrifuge, so as to yield a solid. The solid was put into 1,000 g of water, dispersed by a homogenizer, and then subjected to solid-liquid separation by the centrifuge. This operation of dispersion and solid-liquid separation was repeated until the chlorine content and pH became the values shown in Table 2, so as to yield an indium-tin mixed hydroxide. The chlorine contents in Table 2 were measured by a fluorescent x-ray analyzer (type: ZSX100e manufactured by Rigaku Corporation). In Table 2, “undetectable” refers to the case where the chlorine content is 10 ppm or less. The pH in Table 2 was measured by a pH meter (type: HM-40S manufactured by TOA Corporation) with a sample stood still for 10 minutes after being made by mixing 1 g of the transparent conductive material with 99 g of water. Here, Example 1 uses a sample dried for 1 hr at 100° C. after mixing an indium-tin mixed oxide whose chlorine content was at a detection limit or less with an aqueous solution of 1-N acetic acid.

This indium-tin mixed hydroxide was dried by a spray drier, and then was heated for 1 hr at 600° C. in a nitrogen atmosphere, so as to yield an indium-tin mixed oxide as a transparent conductive material.

Next, thus obtained transparent conductive material, an acrylic monomer (a liquid of equimolecular mixture of methyl methacrylate and polyethylene glycol dimethacrylate with 1 wt % of a UV-curing agent added thereto), and methylethylketone were compounded and mixed such as to yield 20 vol % of the transparent conductive material after evaporating methylethylketone, thereby making a paste.

This paste was applied to a 5-cm square glass substrate by spin coating, the rotating speed was adjusted such as to attain a film thickness of 5 μm after evaporating methylethylketone, and the resulting film was irradiated with UV, so as to yield a transparent conductive film.

### Example 7

A transparent conductive film was obtained as in Example 1 except that the chlorine content control was performed as follows by using ammonium chloride. Namely, the chlorine content control was effected by mixing an indium-tin mixed oxide whose chlorine content was at the detection limit or less with an aqueous solution of 1-N ammonium chloride. In Example 7, they were mixed while being compounded such as to yield a pH of about 7, thereby generating a white precipitate (coprecipitate).

### Comparative Examples 1 to 3

A transparent conductive film was obtained as in Example 1 except that an indium-tin mixed hydroxide was yielded by repeating an operation of dispersing the materials by a homogenizer and effecting the solid-liquid separation by a centrifuge, and compounding them such that the chlorine content and pH became the values shown in Table 2. They were mixed while being compounded such as to yield a pH of about 5 to 7 in Comparative Examples 1 and 2 and a pH of about 9 in Comparative Example 3, thereby generating a white precipitate (coprecipitate).

### Examples 11 to 14 and Comparative Example 4

An aqueous solution dissolving 26 g of stannic chloride (manufactured by Kanto Chemical Co., Inc.) into 974 g of water and a 10-fold water dilution of aqueous ammonia (manufactured by Kanto Chemical Co., Inc.) were mixed while being adjusted so as to yield a pH of about 5 to 7, thereby generating a white precipitate (coprecipitate).

The liquid containing thus generated precipitate was subjected to solid-liquid separation by a centrifuge, so as to yield a solid. The solid was put into 1,000 g of water, dispersed by a homogenizer, and then subjected to solid-liquid separation by the centrifuge. This operation of dispersion and solid-liquid separation was repeated until the chlorine content and pH became the values shown in Table 3, so as to yield a tin hydroxide. Here, Example 11 uses a sample dried for 1 hr at 100° C. after mixing a tin mixed oxide whose chlorine content is at a detection limit or less with an aqueous solution of 1-N nitric acid.

This tin hydroxide was dried by a spray drier, and then was heated for 1 hr at 600° C. in a nitrogen atmosphere, so as to yield a tin oxide.

Next, thus obtained transparent conductive material, an acrylic monomer (a liquid of equimolecular mixture of methyl methacrylate and polyethylene glycol dimethacrylate with 1 wt % of a UV-curing agent added thereto), and methylethylketone were compounded and mixed such as to yield 20 vol % of the transparent conductive material after evaporating methylethylketone, thereby making a paste.

This paste was applied to a 5-cm square glass substrate by spin coating, and the rotating speed was adjusted such as to attain a film thickness of 5 μm after evaporating methylethylketone. The resulting film was irradiated with V, so as to yield a transparent conductive film.

### Examples 15 to 19 and Comparative Examples 5 and 6

An aqueous solution dissolving 10 g of zinc chloride (manufactured by Kanto Chemical Co., Inc.) into 990 g of water and a 10-fold water dilution of aqueous ammonia (manufactured by Kanto Chemical Co., Inc.) were mixed while being compounded so as to yield a pH of about 5 to 7 in Examples 15 to 18 and Comparative Example 5 and a pH of about 9 in Example 19 and Comparative Example 6, thereby generating a white precipitate (coprecipitate).

The liquid containing thus produced precipitate was subjected to solid-liquid separation by a centrifuge, so as to yield a solid. The solid was put into 1,000 g of water, dispersed by a homogenizer, and then subjected to solid-liquid separation by the centrifuge. This operation of dispersion and solid-liquid separation was repeated until the chlorine content and pH became the values shown in Table 4, so as to yield a zinc hydroxide. Here, Examples 15 and 19 and Comparative Example 6 use samples dried for 1 hr at 100° C. after mixing a zinc oxide whose chlorine content is at a detection limit or less with an aqueous solution of 1-N acetic acid.

This zinc hydroxide was dried by a spray drier, and then was heated for 1 hr at 600° C. in a nitrogen atmosphere, so as to yield a zinc oxide.

Thus obtained transparent conductive material, an acrylic monomer (a liquid of equimolecular mixture of methyl methacrylate and polyethylene glycol dimethacrylate with 1 wt % of a UV-curing agent added thereto), and methylethylketone were compounded and mixed such as to yield 20 vol % of the transparent conductive material after evaporating methylethylketone, thereby making a paste.

This paste was applied to a 5-cm square glass substrate by spin coating, and the rotating speed was adjusted such as to attain a film thickness of 5 μm after evaporating methylethylketone. The resulting film was irradiated with UV, so as to yield a transparent conductive film.

Resistance Value Change

In the following manner, changes in resistance values were measured in the transparent conductive films obtained as mentioned above. Namely, surface resistance measurement points of the transparent conductive films were determined beforehand, and were measured with a four-probe surface resistance meter (MCP-T600 manufactured by Mitsubishi Chemical Corporation). Subsequently, the transparent conductive films were left for 1,000 hr at 60° C., 95% RH, and then was taken out and left in the air for 1 hr. The measurement points of the transparent conductive films were measured again. The resulted changes in resistance value between before and after humidification are shown in Tables 2 to 4.

Measurement of Compressed Powder Resistance

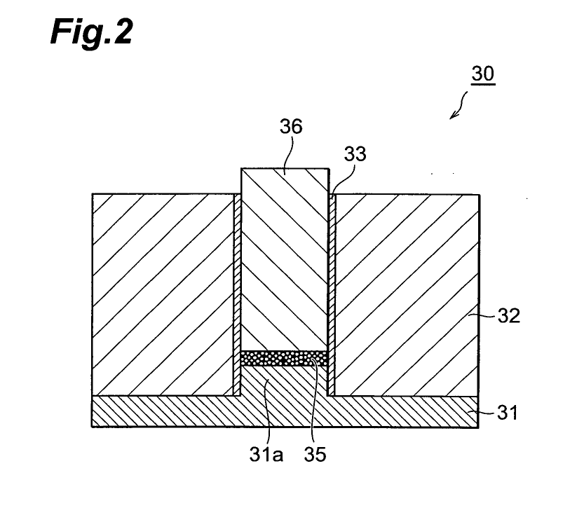

The compressed powder resistance was measured by the apparatus shown in FIG. 2. At the bottom part, this apparatus 30 includes a stainless jig 31 whose center portion is provided with a projection 31a having a diameter of 15 mm and a height of 6 mm, whereas the peripheral part of the stainless jig 31 excluding the projection 31a is provided with a cylindrical drum 32 made of stainless having a diameter of 50 mm, a length of 25 mm, and an inner diameter of 17 mm. The inner wall part of the drum 32 is provided with an insulating plastic inner 33 having a thickness of 1 mm, whereas the side face of the projection 31a and the inner wall part of the drum 32 hold the above-mentioned inner 33 therebetween. The upper face of the projection 31a is made flat so as to be able to mount a sample 35.

Onto the upper face of the projection 31a in the apparatus 30, 2 g of the sample 35 of Example 1 to 10 or Comparative Example 1 to 3 were inserted. Then, a cylinder 36 having a diameter of 15 mm and a length of 50 mm corresponding to the size of the void formed by the drum 32 and inner 33 was inserted into the void, and a force of 50 kN was applied thereby to the sample 35, so as to yield a compressed powder, whereas the compressed powder resistance value between the stainless jig 31 and the cylinder 36 at that time was measured. The results are shown in Tables 2 to 4.

Comprehensive Evaluation

The resistance value change and compressed powder resistance were evaluated. Criteria for the evaluation were such that those excellent, good, and bad were referred to as “A”, “B”, and “C”, respectively, as shown in Table 1. In Table 1, ITO refers to the evaluation in the case where the conductive material is ITO (Examples 1 to 10 and Comparative Examples 1 to 3), SnO₂ refers to the evaluation in the case where the conductive material is SnO₂ (Examples 11 to 14 and Comparative Example 4), and ZnO refers to the evaluation in the case where the conductive material is ZnO (Examples 15 to 19 and Comparative Examples 5 and 6).

TABLE 1

| Material | Excellent A | Good B | Bad C |
|---|---|---|---|
| ITO | resistance value change ≦2 | resistance value change ≦10 | resistance value change ≧10 |
| | times and compressed powder | times and compressed powder | times or compressed powder |
| | resistance value ≦0.1 Ω | resistance value ≦0.15 Ω | resistance value ≧0.15 Ω |
| SnO₂ | resistance value change ≦2 | resistance value change ≦10 | resistance value change ≧10 |
| | times and compressed powder | times and compressed powder | times or compressed powder |
| | resistance value ≦0.15 Ω | resistance value ≦0.25 Ω | resistance value ≧0.25 Ω |
| ZnO | resistance value change ≦2 | resistance value change ≦10 | resistance value change ≧10 |
| | times and compressed powder | times and compressed powder | times or compressed powder |
| | resistance value ≦0.3 Ω | resistance value ≦0.5 Ω | resistance value ≧0.5 Ω |

TABLE 2

| | Transparent | Chlorine | | Resistance value | Compressed powder | |
|---|---|---|---|---|---|---|
| | conductive | content | pH at water | change | resistance value | |
| | material | (mass %) | dispersion | (times) | (Ω) | Evaluation |
| Example 1 | ITO | undetectable | 3.0 | 1.18 | 0.05 | A |
| Example 2 | ITO | 0.08 | 3.9 | 1.16 | 0.06 | A |
| Example 3 | ITO | 0.10 | 3.7 | 1.33 | 0.06 | A |
| Example 4 | ITO | 0.11 | 3.5 | 2.13 | 0.06 | B |
| Example 5 | ITO | 0.20 | 2.9 | 5.83 | 0.05 | B |
| Example 6 | ITO | 0.30 | 3.1 | 4.02 | 0.05 | B |
| Example 7 | ITO | 0.50 | 7.5 | 1.45 | 0.07 | A |
| Example 8 | ITO | 0.06 | 5.0 | 1.13 | 0.07 | A |
| Example 9 | ITO | 0.07 | 8.8 | 1.27 | 0.13 | B |
| Example 10 | ITO | 0.08 | 9.0 | 1.35 | 0.12 | B |
| Comparative | ITO | 0.72 | 2.5 | 6.75 × 10⁸ | 0.05 | C |
| Example 1 | | | | | | |
| Comparative | ITO | 0.59 | 2.7 | 9.76 × 10⁴ | 0.05 | C |
| Example 2 | | | | | | |
| Comparative | ITO | 0.09 | 9.3 | 1.42 | 0.30 | C |
| Example 3 | | | | | | |

TABLE 3

| | Transparent | Chlorine | | Resistance value | Compressed powder | |
|---|---|---|---|---|---|---|
| | conductive | content | pH at water | change | resistance value | |
| | material | (mass %) | dispersion | (times) | (Ω) | Evaluation |
| Example 11 | SnO₂ | undetectable | 1.0 | 1.59 | 0.13 | A |
| Example 12 | SnO₂ | 0.55 | 3.0 | 1.03 | 0.14 | A |
| Example 13 | SnO₂ | 1.0 | 2.0 | 1.19 | 0.12 | A |
| Example 14 | SnO₂ | 1.50 | 1.8 | 4.20 | 0.16 | B |
| Comparative | SnO₂ | 2.56 | 1.3 | 3.14 × 10¹ | 0.14 | C |
| Example 4 | | | | | | |

TABLE 4

| | Transparent | Chlorine | | Resistance value | Compressed powder | |
|---|---|---|---|---|---|---|
| | conductive | content | pH at water | change | resistance value | |
| | material | (mass %) | dispersion | (times) | (Ω) | Evaluation |
| Example 15 | ZnO | undetectable | 4.0 | 9.18 | 0.25 | B |
| Example 16 | ZnO | 0.02 | 5.7 | 1.42 | 0.29 | A |
| Example 17 | ZnO | 0.04 | 5.0 | 1.71 | 0.28 | A |
| Example 18 | ZnO | O.05 | 4.3 | 3.48 | 0.23 | B |
| Example 19 | ZnO | undetectable | 8.8 | 6.48 | 0.35 | B |
| Comparative | ZnO | 0.07 | 3.5 | 2.47 × 10¹ | 0.21 | C |
| Example 5 | | | | | | |
| Comparative | ZnO | undetectable | 9.3 | 1.14 × 10¹ | 0.36 | C |
| Example 6 | | | | | | |

As can be seen from Table 2, it has been found that Examples 1 to 10 concerning ITO exhibit resistance value changes much smaller than those of Comparative Examples 1 and 2 similarly concerning ITO and can fully prevent the resistance value from rising with time. It has also been found that Examples 1 to 10 concerning ITO can make the resistance value of compressed powder much smaller than that of Comparative Example 3 similarly concerning ITO. As can be seen from Table 3, it has been found that each of Examples 11 to 14 concerning SnO₂ exhibits a resistance value change much smaller than that of Comparative Example 4 similarly concerning SnO₂ and can fully prevent the resistance value from rising with time. As can be seen from Table 4, it has also been found that Examples 15 to 19 concerning ZnO exhibit resistance value changes much smaller than those of Comparative Examples 5 and 6 similarly concerning ZnO and can fully prevent the resistance value from rising with time.

The foregoing results have verified that the transparent conductive material of the present invention can fully prevent the resistance value from changing with time even in the high-humidity environment.

### INDUSTRIAL APPLICABILITY

The present invention can provide a transparent conductive material, a transparent conductive paste, a transparent conductive film, and a transparent electrode which can fully prevent the resistance value from changing with time even in the high-humidity environment, and they can favorably be used in LCD, PDP, organic EL, touch panels, and the like.

1. A transparent conductive material containing indium oxide or an indium mixed oxide made by doping indium oxide with at least one species of element selected from the group consisting of tin, zinc, tellurium, silver, gallium, zirconium, hafnium, and magnesium;
wherein the transparent conductive material makes a mixed liquid containing 1 wt % of the transparent conductive material attain a pH of at least 3.

2. A transparent conductive material according to claim 1, wherein the transparent conductive material makes the mixed liquid containing 1 wt % of the transparent conductive material attain a pH of 4 to 9.

3. A transparent conductive material containing indium oxide or an indium mixed oxide made by doping indium oxide with at least one species of element selected from the group consisting of tin, zinc, tellurium, silver, gallium, zirconium, hafnium, and magnesium;
wherein the transparent conductive material makes a mixed liquid containing 1 wt % of the transparent conductive material attain a pH of less than 3 and has a halogen element concentration of 0.2 mass % or less.

4. A transparent conductive material containing tin oxide or a tin mixed oxide made by doping tin oxide with at least one species of element selected from the group consisting of antimony, zinc, and fluorine;
wherein the transparent conductive material makes a mixed liquid containing 1 wt % of the transparent conductive material attain a pH of at least 1 and has a halogen element concentration of 1.5 mass % or less.

5. A transparent conductive material containing zinc oxide or a zinc mixed oxide made by doping zinc oxide with at least one species of element selected from the group consisting of aluminum, gallium, indium, boron, fluorine, and manganese;
wherein the transparent conductive material makes a mixed liquid containing 1 wt % of the transparent conductive material attain a pH of 4 to 9.

6. A transparent conductive paste containing the transparent conductive material according to claim 1.

7. A transparent conductive film containing the transparent conductive material according to claim 1.

8. A transparent electrode comprising a substrate and a transparent conductive layer provided on one side of the substrate, the transparent conductive layer containing the transparent conductive material according to claim 1.

9. A transparent conductive paste containing the transparent conductive material according to claim 2.

10. A transparent conductive paste containing the transparent conductive material according to claim 3.

11. A transparent conductive paste containing the transparent conductive material according to claim 4.

12. A transparent conductive paste containing the transparent conductive material according to claim 5.

13. A transparent conductive film containing the transparent conductive material according to claim 2.

14. A transparent conductive film containing the transparent conductive material according to claim 3.

15. A transparent conductive film containing the transparent conductive material according to claim 4.

16. A transparent conductive film containing the transparent conductive material according to claim 5.

17. A transparent electrode comprising a substrate and a transparent conductive layer provided on one side of the substrate, the transparent conductive layer containing the transparent conductive material according to claim 2.

18. A transparent electrode comprising a substrate and a transparent conductive layer provided on one side of the substrate, the transparent conductive layer containing the transparent conductive material according to claim 3.

19. A transparent electrode comprising a substrate and a transparent conductive layer provided on one side of the substrate, the transparent conductive layer containing the transparent conductive material according to claim 4.

20. A transparent electrode comprising a substrate and a transparent conductive layer provided on one side of the substrate, the transparent conductive layer containing the transparent conductive material according to claim 5.
